(19) United States
(12) Patent Application Publication
(10) Pub. No.: US 2013/0036371 A1
(43) Pub. Date: Feb. 7, 2013

(54) Virtual World Overlays, Related Software, Methods of Use and Production Thereof

(71) Applicant: Aaron D. Cohen, Newark, CA (US)

(72) Inventor: Aaron D. Cohen, Newark, CA (US)

(21) Appl. No.: 13/195,532

(22) Filed: Aug. 1, 2011

(51) Int. Cl. G06F 3/048; G06F 15/16

(52) U.S. Cl. 715/757

(57) ABSTRACT

Multi-dimensional enhanced world view experiences are described herein that include: a) at least one software-enabled device, network device, portable device or combination thereof; b) at least one interactive application that provides at least one virtual world overlay, virtual object or combination thereof; and c) at least one physical view, wherein the at least one virtual world overlay, virtual object or combination thereof is aligned or overlaid with the at least one physical view to produce an enhanced world view that is displayed on the at least one software-enabled device, network device, portable device or a combination thereof. Corresponding methods of producing multi-dimensional enhanced world view experiences also include: a) providing at least one software-enabled device, network device, portable device or combination thereof; b) providing at least one interactive application that provides at least one virtual world overlay, virtual object or combination thereof; and c) providing at least one physical view, wherein the at least one virtual world overlay, virtual object or combination thereof is aligned or overlaid with the at least one physical view to produce an enhanced world view that is displayed on the at least one software-enabled device, network device, portable device or a combination thereof.

### FIELD OF THE SUBJECT MATTER

The field of the subject matter is virtual world overlays, related software, methods of use and production thereof.

### BACKGROUND

Consumers are increasing their demand for new interactive experiences, especially those that combine the best of virtual worlds with the real world and/or reality. Early applications of virtual reality developed two, three and sometimes four dimensional images that a user could explore on a computer or on a television-based device. As portable devices, hand-held devices and smartphones started to become indispensible devices to many consumers, virtual worlds had to move away from “cabled” devices and out to wireless and portable devices.

One group of patents and patent publications, including U.S. Pat. Nos. 6,965,855, 7,092,014, 6,330,486, 7,343,268, 6,124,862, 6,859,768, 5,307,295 and US Patent Publication Nos. 2002/0082879, 20040032489 and 2004/0004612 describe building and/or designing virtual three-dimensional worlds that are based on current venues and buildings or those venues and buildings that will be built in the future. Consumers are able to place furniture and fixtures, paint and wallpaper and other items in the simplest applications. In the most complex applications, users are able to view venues for concerts, sporting events, theater shows and other events, view the selected seats, the view from the seats and even what the sound or ambiance is like in that particular seat. These applications are moving to the portable and hand-held devices and “apps” or software applications, so that consumers can get this information on their iPad, smartphone or other tablet device.

Another use of augmented or virtual reality is focused on only the immediate area around a user, which can be quite limiting. For instance, there is a program that lets you look at your smart phone screen and kick a “virtual” soccer ball. In this case, the phone's camera estimates where your foot is and knows where to draw the ball. If you kick at the virtual ball, the phone knows how to animate the ball to simulate it being kicked. All the work happens within the phone or portable device. This process is similar to the process currently used with golf simulations, where a consumer holds a club, swings the club and the software animates a ball being hit on a screen in front of the user. The software estimates the speed and direction of the club to provide an accurate projection of the trajectory and distance of the ball. Basically, most current uses of augmented or virtual reality work the same way. A device combines a real world view and adds a virtual element, a monster to shoot, a ball to kick, or something to interact with locally. In other words, the actual device, the hardware and software on the individual device controls the reality.

To this end, it would be desirable to form and utilize a virtual experience that a) is not device specific or individualized and/or stored on the specific device; b) can provide a view of virtual objects and projections on the user's device, c) can provide views of virtual objects that are not user specific, d) can immerse the user and/or consumer in a complete virtual world; and e) can be educational, useful or fun for the user and/or consumer.

### SUMMARY OF THE SUBJECT MATTER

Multi-dimensional enhanced world view experiences are described herein that include: a) at least one software-enabled device, network device, portable device or combination thereof; b) at least one interactive application that provides at least one virtual world overlay, virtual object or combination thereof; and c) at least one physical view, wherein the at least one virtual world overlay, virtual object or combination thereof is aligned or overlaid with the at least one physical view to produce an enhanced world view that is displayed on the at least one software-enabled device, network device, portable device or a combination thereof.

Corresponding methods of producing multi-dimensional enhanced world view experiences also include: a) providing at least one software-enabled device, network device, portable device or combination thereof; b) providing at least one interactive application that provides at least one virtual world overlay, virtual object or combination thereof; and c) providing at least one physical view, wherein the at least one virtual world overlay, virtual object or combination thereof is aligned or overlaid with the at least one physical view to produce an enhanced world view that is displayed on the at least one software-enabled device, network device, portable device or a combination thereof.

Multi-dimensional enhanced world view experiences are described herein that include: a) at least one software-enabled device, network device, portable device or combination thereof; b) at least one interactive application comprising an executable code, wherein the application is stored on a network computer system and provides at least one virtual world overlay, virtual object or combination thereof; and c) at least one physical view, wherein the executable code is executed in order to align the at least one virtual world overlay, virtual object or combination thereof with the at least one physical view to produce an enhanced world view that is displayed on the at least one software-enabled device, network device, portable device or a combination thereof.

Corresponding methods of producing multi-dimensional enhanced world view experiences are described herein that include: a) providing at least one software-enabled device, network device, portable device or combination thereof; b) providing at least one interactive application comprising an executable code, wherein the application is stored on a network computer system and provides at least one virtual world overlay, virtual object or combination thereof; and c) providing at least one physical view; wherein the executable code is executed in order to align the at least one virtual world overlay, virtual object or combination thereof with the at least one physical view to produce an enhanced world view that is displayed on the at least one software-enabled device, network device, portable device or a combination thereof.

### BRIEF DESCRIPTION OF THE FIGURES

FIG. 1 shows a contemplated example of the enhanced world view experience system.

FIG. 2 shows a contemplated example of the enhanced world view experience system.

FIG. 3 shows a contemplated example of the enhanced world view experience system.

FIG. 4 shows a contemplated example of the enhanced world view experience system.

FIG. 5 shows a contemplated example of the enhanced world view experience system.

FIG. 6 shows a contemplated example of the enhanced world view experience system.

### DETAILED DESCRIPTION

As described in detail herein, a virtual experience has been developed that a) is not device specific or individualized and/or stored on the specific device; b) provides a view of virtual objects and projections on the user's device, c) provides views of virtual objects that are not user specific, d) immerses the user and/or consumer in a complete virtual world; and e) is educational, useful or fun for the user and/or consumer. Contemplated virtual experiences create immersive, challenging, and entertaining experiences never before possible, including experiences not even remotely possible with the current uses of augmented reality. These virtual experiences, as contemplated and disclosed herein, are referred to as “enhanced world view experiences” or “enhanced experiences”—both of which are meant to be interchangeable and refer to the same contemplated embodiments. These enhanced experiences can be multi-dimensional, which means that contemplated enhanced experiences are at least two dimensional and may be three dimensional or four dimensional where the fourth dimension introduces a time aspect to the virtual object or overlay.

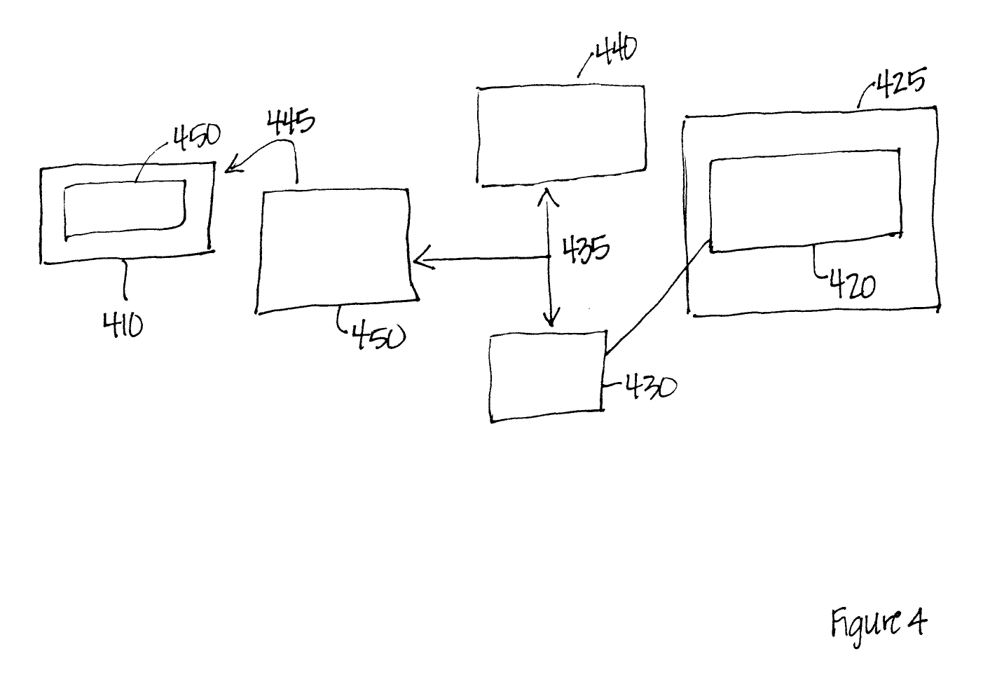

Specifically, a multi-dimensional enhanced world view experience 300 is described herein that includes: a) at least one software-enabled device, network device, portable device or combination thereof 310; b) at least one interactive application 320 that provides at least one virtual world overlay, virtual object or combination thereof 330; and c) at least one physical view 340; wherein the at least one virtual world overlay, virtual object or combination thereof 330 is aligned 335 with or overlaid on the at least one physical view 340 to produce an enhanced world view 350, as shown in FIG. 3. This enhanced world view 350 is then device-viewable 345 on the at least one software-enabled device 310.

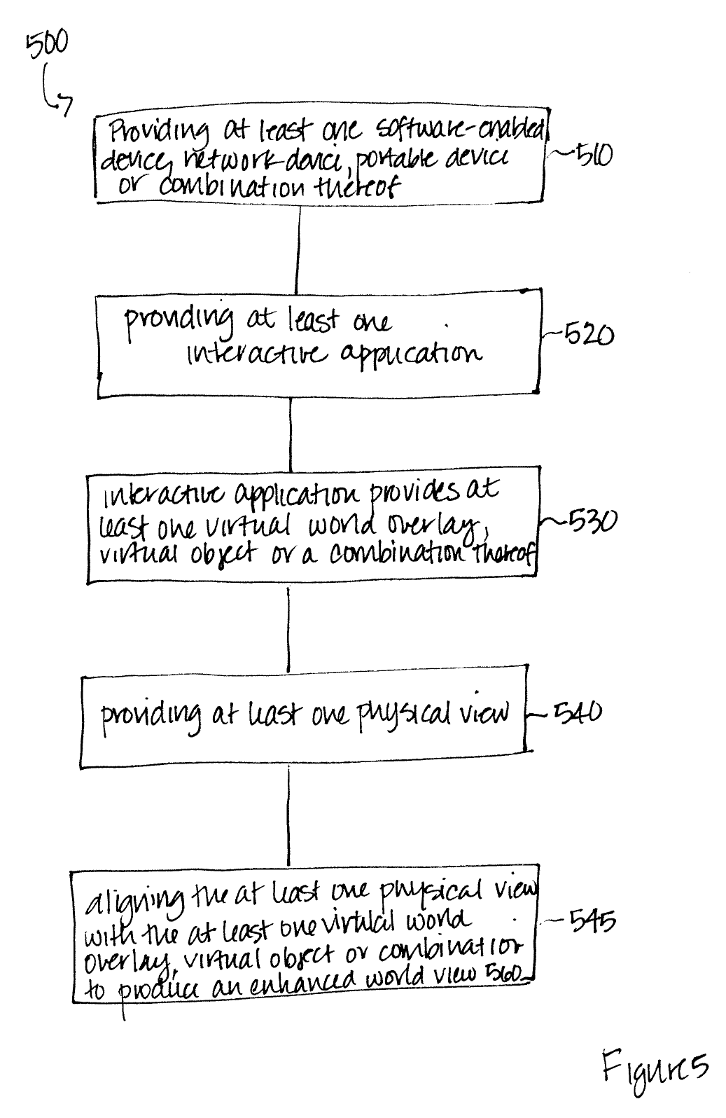

Multi-dimensional enhanced world view experiences 400 are described herein that include: a) at least one software-enabled device, network device, portable device or combination thereof 410; b) at least one interactive application 420 comprising an executable code (not shown), wherein the application is stored on a network computer system 425 and provides at least one virtual world overlay, virtual object or combination thereof 430; and c) at least one physical view 440, wherein the executable code is executed in order to align 435 the at least one virtual world overlay, virtual object or combination thereof 430 with the at least one physical view to produce an enhanced world view 450, as shown in FIG. 4. This enhanced world view 450 is then device-viewable 445 on the at least one software-enabled device 410.

The enhanced world view experience produces, stores and lays out a virtual world on top of the real world. It will allow people to interact with virtual creatures, agents, sets, signs, special effects, buildings or structures that are made to appear as if they are within the real world. In addition, it will allow people to view others interacting with virtual creatures, agents, sets, signs, special effects, buildings or structures that are made to appear as if they are within the real world. In this latter option, it is contemplated that the user is using his or her at least one software-enabled device, network device, portable device or combination thereof to view another user who is experiencing his or her own enhanced world view experience. In some embodiments, as disclosed herein, a user can develop a virtual home or building using this type of development software and then view the virtual home on a portable device or smart phone as overlaid or aligned with the original home or building. In this embodiment, it is the user's proximity to the original home or building in combination with the executable code on the portable device or smart phone that allows the user to view the virtual home stored on a network or other similar system.

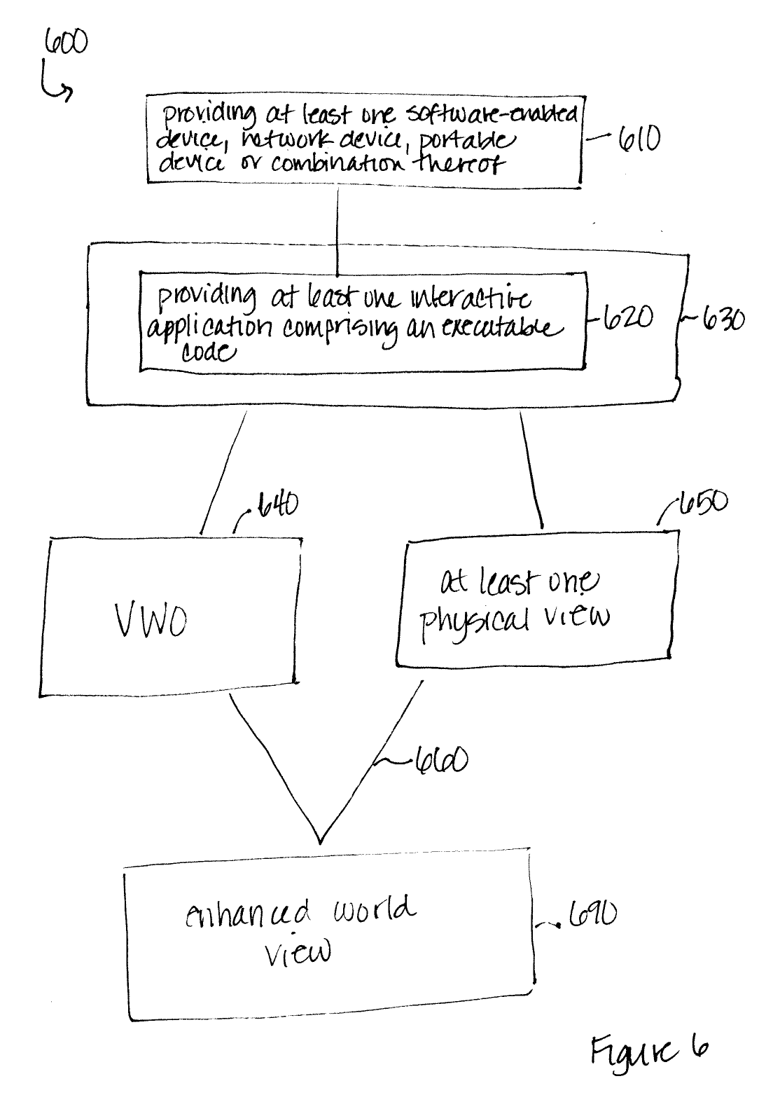

Corresponding methods of producing multi-dimensional enhanced world view experiences 500 also include: a) providing at least one software-enabled device, network device, portable device or combination thereof 510; b) providing at least one interactive application 520 that provides at least one virtual world overlay, virtual object or combination thereof 530; and c) providing at least one physical view 540; wherein the at least one virtual world overlay, virtual object or combination thereof is aligned 545 with the at least one physical view 540 to produce an enhanced world view 560, as shown in FIG. 5.

Additional methods of producing multi-dimensional enhanced world view experiences 600 are described herein that include: a) providing at least one software-enabled device, network device, portable device or combination thereof 610; b) providing at least one interactive application comprising an executable code 620, wherein the application is stored on a network computer system 630 and provides at least one virtual world overlay, virtual object or combination thereof 640; and c) providing at least one physical view 650; wherein the executable code 620 is executed 660 in order to align the at least one virtual world overlay, virtual object or combination thereof 640 with the at least one physical view 650 to produce an enhanced world view 690, as shown in FIG. 6.

As described herein, contemplated enhanced world view experiences comprise at least one interactive application that provides at least one virtual world overlay, virtual object or combination thereof. It should be understood that contemplated at least one interactive applications do not reside or are not stored on the user's at least one software-enabled device, network device, portable device or combination thereof. A contemplated at least one interactive application resides on a central server, network server, a central Cloud or another multi-user accessible and/or two-way system that is not directly associated with the device. The device has its own executable code that is designed to communicate with the central server, network server, a central Cloud or another multi-user accessible and/or two-way system.

As also disclosed herein, contemplated enhances world view experiences comprise at least one physical view; wherein the at least one virtual world overlay, virtual object or combination thereof is aligned with the at least one physical view to produce an enhanced world view. Contemplated physical views comprise an animate or inanimate object—whether motorized or stable—that is tangible.

What distinguishes the multi-dimensional enhanced world view experiences from other experiences described, for example, in the Background Section is that contemplated multi-dimensional enhanced world view experiences comprise interactive applications, such as global overlays or virtual objects and are not localized events. These contemplated interactive applications, such as global overlays or virtual objects are produced, stored and/or controlled by a centralized server, database or other interactive storage source, as mentioned earlier. Contemplated interactive applications, such as global overlays or virtual objects are not produced, stored and/or controlled by the user's individual device. They are however viewed on the user's individual device, which is also tangible hand-held object.

Contemplated virtual objects or “VO”s that exist within contemplated interactive applications, such as global overlays or virtual objects, are designed to apply to geographically fixed locations regardless of the user or users locations and devices. In other words, contemplated interactive applications and the virtual objects that exist within them exist for users to access despite the fact that there may not be any users at or near the space to access them at any point in time.

Contemplated interactive applications, such as global overlays or virtual objects, will be placed in contemplated enhanced world view experiences and controlled by a centralized server, which is the primary difference between existing augmented reality application and the enhanced world view experiences, as described earlier. The enhanced world view experiences, because they are server controlled, create worlds independent of the devices that display the enhanced world view experiences. This server-controlled logic is what allows users to view other users interacting in the enhanced world view experience.

A viewer can see VOs through any device that can communicate through internet with the contemplated enhanced world view experience servers. These devices would include, but are not limited to, smart phones, tablet computers, wirelessly-enabled glasses and headgear, laptop computers or combinations thereof. In most cases, these devices will have cameras or other image capture devices/cables that can see the real world display the VOs on top of the real world. However, it is possible that a device could see the VOs and interact with the enhanced world view experiences without needing a camera based primarily on a global positioning aspect, such as global positioning software located in most portable devices.

In some contemplated embodiments, users can experience contemplated embodiments through contemplated glasses that will allow the wearer to see anything happening within a specific enhanced environment. Contemplated glasses would be worn much like people wear 3D glasses and would be set to a specific enhanced experience, letting the wearer chose between, for instance, an RPG, a murder mystery, or an advertising stunt. Once linked to a specific experience, the wearer will see whatever is going on within that specific enhanced environment.

In some contemplated embodiments, it may be useful for enhanced environment maps that track enhanced environment locations and how events within the enhanced environment are progressing to be viewed on a web-based, top-down global map where specific points can be searched through and located. For instance, viewers might want to see a map where all the virtual homes in a city are, and what they will look like. They would be able to go to a tracking website that is connected to the enhanced environment server to see all the virtual home locations and get details on each one.

For some applications (like the Virtual Tour in Example 2), enhanced world view experience designers establish the best locations for most or all elements within an enhanced world view experience, be they tour guides, famous cartoon characters, figures from history, sky scrapers, houses, castles or others venues, buildings, people, characters or a combination thereof.

For other applications (like the Virtual Home makeover in Example 1), users can create and customize objects and then put them into an enhanced world view experience. These would include everything from homes to fictional characters to monsters. It primarily depends on the intent of the application.

For contemplated commercial applications, a business, in order to drive foot traffic and/or word of mouth, could pay a license fee to have designer do a virtual make over, changing a coffee shop into pirate ship filled with talking, interactive scallywags, or turn an entire shopping mall into a massive haunted house filled with interactive ghosts.

Additional contemplated applications of enhanced world view experiences include:
Advertising. For example, perhaps at the opening for a movie about Spider-Man, an enhanced world view experience can have a virtual Spider-Man swinging around every metropolitan area. As movie goers walk into a theater, they can look up through their smart phones and see Spider-Man swinging around.
Entertainment. With an enhanced world view experience, you could create a scripted movie where virtual actors act out the story on location. You could have Godzilla battle Megatron in the middle of Times Square on New Year's Eve, and everyone there would be able to watch.
Travel. A traffic enhanced world view experience could be placed over roads and highways, functioning as a GPS that you are actually driving through. Instead of have to look at the small screen of a GPS in your car, and then look back at the road, the enhanced world view experience might put a big, blazing sign right at the street where you should turn left.
Creative Expression. Creators using tools designed to put things into an enhanced world view experience could augment the world in amazing ways that others could see. A creator could fill Central Park with ballet dancers or with fighting dinosaurs.

As described herein, a contemplated enhanced environment creates a virtual world that seamlessly intertwines and interacts with the real world on a tangible device. Only users who have the correct software within their device, smart phones or computers can see and interact with this hidden enhanced environment. Also, it is possible that people who have enhanced environment glasses will also be able to see this hidden world.

Perhaps ten years from now, it will be commonplace for there to be a virtual tour guide at the base of the Eiffel Tower, or at the bottom of the Grand Canyon, or 100 feet underwater standing next to the Great Barrier Reef. It might become quite expected that every October 31 virtual zombies will invade downtown Austin and a virtual Michael Jackson and his dance crew from the Thriller video perform that iconic choreography in the middle of The Mall of Americas in Minneapolis.

### EXAMPLES

### Example 1

### The Virtual Home Makeover Application

This application will allow home owners to design dream homes (or even nightmare homes or fantasy homes) and then use the contemplated virtual overlays to drop those virtual homes over their real homes. The virtual homes, now virtual objects existing in the enhanced world view experience, will be visible to all who view the home through the Virtual Home Makeover application on their smart phone, portable device or personal computer (PC).

Users could design haunted homes for Halloween or fanciful holiday homes for Christmas. The software would be constantly updated with new design objects, textures and templates.

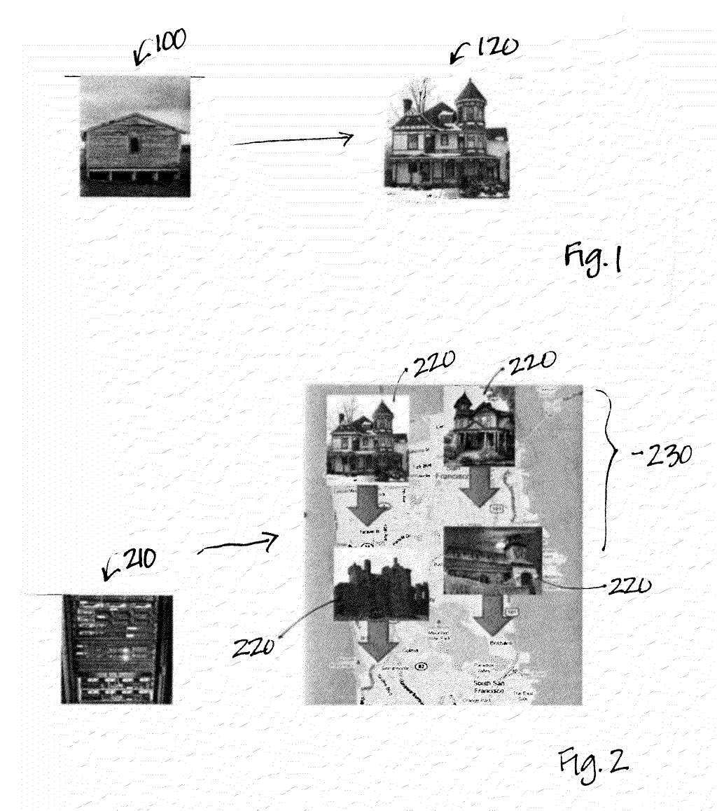

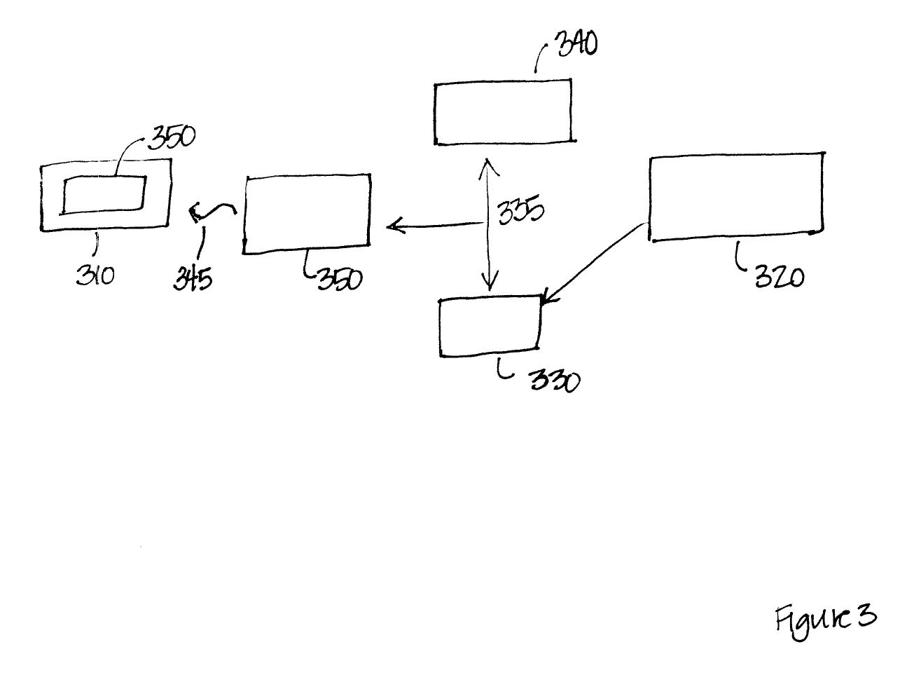

Once the virtual home is designed, the user uploads it to the enhanced world view experience on a centralized server, database or other suitable interactive storage device, and the enhanced world view experience will begin displaying it as a virtual overlay. The enhanced world view experience servers will keep track of where all the virtual homes are and display them to viewers using the application. An example of this process is shown in FIGS. 1 and 2.

In FIG. 1, a plain home 100 is shown. This plain home is the actual home as the person sees it when standing in front of it and looking at it. The homeowner can then use software (not shown) to design how she would like her home to look—maybe after a remodel or renovation. The homeowner can then use her portable device or smart phone (not shown) to view the new designed virtual home 120 layered over the actual plain home 100. Other viewers (not shown) can be allowed to see the new designed virtual home 120 on their portable devices or smart phones when they drive by.

FIG. 2 shows a contemplated network server 210 that keeps track of where all of the virtual homes 220 are in a certain area 230. Viewers (not shown) can use a portable device or smart phone (not shown) to view the virtual homes 220 as they drive or walk around the area 230.

### Example 2

### The Virtual Tour Guide Application

With this application, viewers run the application in their smart phones and choose, for example, The Historic Walking Tour of San Francisco. They start at a pre-determined point, where they are met by a virtual tour guide, who is part of the enhanced world view experience and is controlled by enhanced world view experience servers.

The tour guide will explain to the group key historic points of a given location, and then with a snap of his fingers turn specific areas into what they looked like during an historic time period. For instance, an entire city block could be rebuilt with the enhanced world view experience to look exactly as it did before the great earthquake of 1906.

Note that in this example, the tour guide is a virtual overlay and has the ability to interact in some ways with his audience. He has an artificial intelligence, controlled by the enhanced world view experience servers. He can ask questions and receive answers. (For instance, he could ask, “Would you like to go to North Beach next or Chinatown?”) He can change costumes as he talks about different time periods. He can also change genders, or take on the visages of famous people of history.

It is also instructive to note that at any given time, the tour designers can make changes to the script, or add new tours that would operate in separate enhanced world view experiences. For instance, one tour could be the standard history tour, while another could be all about the 1960s, while another could be a ghost tour, and another could be about the prohibition era and the many speakeasies that were around at the time. This aspect of the contemplated enhanced environments is beneficial for educational services. For example, a class of architecture students may be able to tour a historic area of a city for a day and as they transverse the area, they can view that part of the city as it was developed through each decade or period of time. Geology students can walk through a mountainous area, for example, and see the landscape as it developed or eroded through time.

While one tour groups is in one enhanced world view experience, others could be on a completely tour, experiencing a completely different enhanced world view experience in the same physical location.

Thus, specific embodiments, methods of virtual world overlays, related software, methods of use and production thereof have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A multi-dimensional enhanced world view experience, comprising:
at least one software-enabled device, network device, portable device or combination thereof;
at least one interactive application that provides at least one virtual world overlay, virtual object or combination thereof; and
at least one physical view, wherein the at least one virtual world overlay, virtual object or combination thereof is aligned or overlaid with the at least one physical view to produce an enhanced world view that is displayed on the at least one software-enabled device, network device, portable device or a combination thereof.

2. The multi-dimensional enhanced world view experience of claim 1, wherein the at least one software-enabled device, network device, portable device or combination thereof comprises a smart phone, a tablet computer, wirelessly-enabled glasses, a laptop computer or a combination thereof.

3. The multi-dimensional enhanced world view experience of claim 1, wherein the at least one software-enabled device, network device, portable device or combination thereof comprises an executable software code.

4. The multi-dimensional enhanced world view experience of claim 3, wherein the executable software code is an application.

5. The multi-dimensional enhanced world view experience of claim 4, wherein the application shows the enhanced world view on the at least one software-enabled device.

6. The multi-dimensional enhanced world view experience of claim 1, further comprising at least one network computer system.

7. The multi-dimensional enhanced world view experience of claim 6, wherein the at least one network computer system comprises an executable software code.

8. The multi-dimensional enhanced world view experience of claim 7, wherein the executable code is executed on the network computer system to produce the at least one interactive application.

9. The multi-dimensional enhanced world view experience of claim 1, wherein the at least one interactive application is produced, stored, implemented, controlled or a combination thereof by a centralized server, database, other interactive storage source or combination thereof.

10. The multi-dimensional enhanced world view experience of claim 1, wherein the at least one physical view comprises a view of an existing building, home or other structure.

11. The multi-dimensional enhanced world view experience of claim 1, wherein the at least one physical view comprises a view of an existing vehicle, automobile, motorized device or apparatus, airplane, train or combination thereof.

12. The multi-dimensional enhanced world view experience of claim 1, wherein the at least one physical view comprises a view of an existing building interior, home interior, furniture arrangement or combination thereof.

13. The multi-dimensional enhanced world view experience of claim 1, wherein the enhanced world view is device-viewable.

14. A method of producing a multi-dimensional enhanced world view experience, comprising:
providing at least one software-enabled device, network device, portable device or combination thereof;
providing at least one interactive application that provides at least one virtual world overlay, virtual object or combination thereof; and
providing at least one physical view, wherein the at least one virtual world overlay, virtual object or combination thereof is aligned or overlaid with the at least one physical view to produce an enhanced world view that is displayed on the at least one software-enabled device, network device, portable device or a combination thereof.

15. The method of claim 14, wherein the at least one software-enabled device, network device, portable device or combination thereof comprises a smart phone, a tablet computer, wirelessly-enabled glasses, a laptop computer or a combination thereof.

16. The method of claim 14, wherein the at least one software-enabled device, network device, portable device or combination thereof comprises an executable software code.

17. The method of claim 16, wherein the executable software code is an application.

18. The method of claim 17, wherein the application shows the enhanced world view on the at least one software-enabled device.

19. The method of claim 14, further comprising at least one network computer system.

20. The method of claim 19, wherein the at least one network computer system comprises an executable software code.

21. The method of claim 20, wherein the executable code is executed on the network computer system to produce the at least one interactive application.

22. The method of claim 14, wherein the at least one interactive application is produced, stored, implemented, controlled or a combination thereof by a centralized server, database, other interactive storage source or combination thereof.

23. The method of claim 14, wherein the enhanced world view is device-viewable.
